(19) United States
(12) Patent Application Publication
(10) Pub. No.: US 2006/0161428 A1
(43) Pub. Date: Jul. 20, 2006

(54) Narrowband detector

(76) Inventor: Joachim Fouret, Great Britain (DE)

Correspondence Address: BARNES & THORNBURG, LLP, P.O. BOX 2786, CHICAGO, IL, 60690-2786, US

(21) Appl. No.: 10/537,104

(22) PCT Filed: Dec. 5, 2002
(86) PCT No.: PCT/GB02/05487

§ 371 Date: Nov. 7, 2005

(30) Foreign Application Priority Data
Dec. 6, 2001 (GB) 0129217.6

(51) Int. Cl. G10L 19/02

(52) U.S. Cl. 704/229

(57) ABSTRACT

A narrowband signal detector has an adaptable filter and controller for controlling the centre frequency and the bandwidth of the filter, to track the narrowband signal. Better control of the filter can be achieved by basing the filter control on a comparison of output and input to the filter. The comparison gives a more direct measure of how well the filter is tracking the narrowband signal. In the case of a notch filter, if there is poor tracking. The control should be biased rapidly towards improved tracking speed. Otherwise, for good tracking, the control should be biased towards accuracy of tracking. This enables speed and accuracy of detection requirements to be met with less computational load. Applications include telecommunications signalling or data tone detection. Multiple narrowband signals can be detected by a cascade of filters.

### FIELD OF THE INVENTION

The invention relates to detector arrangements including software and apparatus for detecting narrowband signals, to tone processing arrangements, to apparatus for a central office, to pseudo division circuitry or software, to methods of using an output of such arrangements for control or monitoring purposes, to methods of transmitting voice or data using such arrangements, and to methods of offering a voice or data transmission service using the above.

### BACKGROUND TO THE INVENTION

Detection of narrow-band signals such as tones is used in many fields, including imaging fields such as radar- and sonar-type signal processing, accoustic signal processing, including mechanical vibration detection, and telecommunications. Telecommunication equipment make a heavy use of tones for signaling purposes. Some examples of tone signaling systems are DTMF (dual tone multi-frequency) and MF (multi-frequency) signaling. As a consequence, a variety of different equipment needs to be able to detect and decode these tones to implement the signaling system. Examples of the different equipment include for example, switches for routing calls, modems for transmitting data, voicemail systems, and call-centre systems: Moreover, tone detectors are also useful in other applications where tones could deteriorate their performance. An example of this is an Echo Canceller (EC). Narrow-band signals can corrupt the coefficients of the echo canceller and reduce the voice quality of the phone line. Therefore, these narrow-band signals have to be detected to enable the (Echo Canceller) to take the appropriate measure to protect itself. It may stop adaptation, stop cancellation, or take other measures.

FIG. 1 shows in schematic form a conventional application of a narrow-band detector within the context of telecommunications equipment. In this figure, a narrowband detector 10 is coupled to receive input signals representing telephone calls. The detector outputs signals representing frequencies, and powers of narrowband signals it detects, together with flags to indicate positive detection. A phase reversal detector 20 is provided to detect any phase reversals, as specified in well known signalling standards. The phase reversal detector is fed with the same input signals, and additionally with the outputs of the narrowband detector.

The outputs of the narrowband detector and the phase reversal detector are fed to a tone decoder 30, which classifies the results into standard signalling tones if they meet the standards in terms of duration, frequency and so on. The outputs of this unit are fed to units such as the echo canceller 40, the routing switch 50, the call centre controller 60, and the voicemail system 70. Some or all of these units are typically located in a local exchange or central office 80, coupled to subscribers 90 by subscriber lines 100, and coupled to other exchanges or central offices by trunk lines 110. In this figure, many other elements or connections in the central office are omitted for the sake of clarity.

The narrowband detector can be implemented in various ways. Fourier transform based methods involve determining the frequency spectrum and looking for peaks, and many varieties have been published. Another known technique involves using an adaptive notch filter (ANF) to remove the narrowband tone and measuring the residual or error signal. The centre frequency is adapted continuously to track the tone, to minimise the residual, using one of many possible control algorithms. The power and frequency of the tone can be determined from the residual and the filter centre frequency. This technique is used in various known narrowband detection techniques, including line enhancer, or sinusoidal detection, or cisoid detection, or frequency estimation techniques. An example of an ANF for detecting narrowband signals such as sinusoids, is shown in IEEE transactions on circuits and systems-II Analog and digital signal processing volume 40 No. 7, July 1993, “On the adaptive lattice notch filter for the detection of sinusoids”, by Cho et al.

A paper published by the IEEE in 1998, ref 0-7803-4428-6/98 “an adaptive high-order, notch filter using all-pass sections” by Torres et al, shows an example of an ANF. The adaptation rate is altered for non stationary input signals by altering the notch bandwidth dynamically. It states that the “notch bandwidth broadens when frequency variations are detected, and narrows after convergence has been achieved.” This is in the context of a filter using RPE (recursive prediction error) for adapting the centre frequency of the notch filter to converge on the narrowband signal. Torres also shows tracking multiple narrowband signals, with cascaded notch filters. Each is independently controlled, it says “instead of using the overall output signal to adjust the filter coefficients, this frequency decoupling property enables each section to be independently minimised.”

Another example of an ANF type arrangement is shown in IEEE transactions on signal processing Vol 48, no 2 Feb. 2000 “Multiple fully adaptive notch filter design based on allpass sections” by DeBrunner et al. The arrangement implied by this paper is shown in FIG. 2. In this figure, an input signal is fed to an adaptive notch filter 200. A filter controller 210 is provided having an adaptive algorithm 220 for adapting a centre frequency k of the ANF. The controller also has an adaptive algorithm 230 for adapting a forgetting factor, and an adaptive algorithm 240 for adapting the bandwidth. The bandwidth, the centre frequency, and the forgetting factor are fed back to the ANF. The controller takes as its inputs an error signal and an estimated error gradient output from the ANF. It is also known to have arrangements in which the controller takes the input signal as an approximation of an error gradient.

There are a number of problems with this approach. Firstly, when there are two or more tones with closely spaced frequencies, the algorithm for adapting the ANF bandwidth cannot converge to either one. The error is minimised with the bandwidth being sufficiently wide to cover both tones. However a much narrower bandwidth is desirable to give better accuracy of detected frequency and power.

Secondly, this method provides slow reconvergence for non stationary tones because the forgetting factor is tied to the bandwidth. This means that when the bandwidth is small and the forgetting factor large, and the input tone frequency changes, the forgetting factor will only reduce relatively slowly. Thirdly, the method is relatively computation-intensive.

High speed detection of tones is desirable for many applications. For example, some telecommunication signalling tone standards specify the tone duration may be as little as 40 msecs, and may have a 20 msec interruption. Also, echo cancellers and modems need to detect tones very rapidly to ensure correct operation.

### SUMMARY OF INVENTION

A first aspect of the invention provides a detector arrangement for detecting a narrowband signal in an input signal, the detector having:

an adaptable filter coupled to the input signal and having a frequency response with an adaptable centre frequency, and

a filter controller for controlling the filter, to track the narrowband signal, the controller being dependent on a comparison between the input signal and an output of the filter, the comparison indicating how closely the filter is tracking the narrowband signal.

Better control of the filter can be achieved by basing the filter control on this comparison. The comparison gives a more direct measure of how well the filter is tracking the narrowband signal. In the case of a notch filter, if the output is large relative to the input, this indicates poor tracking. The control should be biased rapidly towards improved tracking speed. Correspondingly, a small output relative to the input, indicates good tracking and the control should be biased towards accuracy of tracking, at the expense of speed of tracking. This improvement in turn enables critical speed and accuracy of detection requirements to be met with less computationally intensive algorithms than previously. It also enables better detection of multiple narrowband signals since there is little possibility of the above mentioned problem of convergence to a minimum error with the bandwidth covering two closely spaced narrowband signals. Using the input signal can effectively prevent this.

Particularly for upgrading existing installations, such as central offices for telephone networks, the amount of processing power in terms of MIPs (millions of instructions per second) is typically a key limitation, limiting the number of calls which can be handled simultaneously. Hence any improvement in calculation efficiency will often translate directly into an increase in call handling capacity, and therefore an increase revenue generating capability.

A preferred way of implementing this feature is to base the control on a ratio of a characteristic of the filter output as a proportion of a characteristic of the input signal. Because the ratio (output/input of the ANFs) reflects directly if the ANFs are tracking the right frequencies or not, then the method can achieve a very fast re-convergence and at the same time converge very accurately. Another preferred feature involves controlling the bandwidth according to the comparison. The bandwidth is one of the best ways of biasing the control between speed and accuracy.

Another preferred feature involves the filter having an adaptable forgetting factor, controlled by the controller. The forgetting factor enables the filter control to be further biased towards fast convergence when hunting for a signal, and biased towards accuracy at the expense of convergence speed, when convergence is achieved.

Another feature is to make the forgetting factor controllable on the basis of the input signal, or the ratio of input and output signal. This can give a further improvement for the same reasons set out above, that the ratio (output/input of the ANFs) reflects directly if the ANFs are tracking the right frequencies or not

Another preferred feature involves the controller using an adaptive algorithm such as a recursive least squares (RLS) algorithm. This provides a good balance of accuracy and speed of convergence, though with a heavy computational load.

Preferably the arrangement is arranged to derive a bandwidth control signal from the input signal and the output of the filter, according to the comparison and to a mapping defining how the bandwidth control is derived.

Preferably the mapping is a linear mapping with limiting of extreme values. Preferably the detector arrangement is arranged to smooth the bandwidth control signal to reduce jitter. This can be done by time averaging, and can improve the balance between accuracy and responsiveness.

Preferably the ratio is derived using a recursive pseudo division process. This can enable the computation load to be reduced considerably, since division operations are computationally intensive, and because the ratio needs to be calculated frequently. This saving is possible because the ratio needs not to be calculated precisely in absolute terms, provided trends are represented accurately.

Preferably the detector has a cascade of filters, to track multiple narrowband signals simultaneously.

Preferably, the detector arrangement has multiple filters being arranged in two or more rows of serially cascaded filters, the controller being arranged to control the filters such that in each row, individual filters track different ones of the narrowband signals, and in the different rows, the same narrowband signals are tracked, but in a different order, the controller further being arranged to use error gradients derived from the outputs of filters of one of the rows, and use residual power outputs from one of the filters in each of the rows. This enables the disadvantages of triangular and series cascades to be reduced.

Another preferred feature involves processing detection of multiple narrowband signals to remove double detections of the same signal, based on frequency difference and power levels.

The arrangement may be in the form of software, recognising the value of software as a separately tradeable and deliverable item which can embody the desired functions, and can become operational with relatively trivial steps such as loading into standard hardware. Another aspect of the invention provides a tone processing system having a narrowband detector, and a tone decoder. Another aspect of the invention provides apparatus for a central office having such a tone processing system.

Another aspect provides software or circuitry arranged to derive an output representing a pseudo division of a signal representing a numerator by an input signal, using a continuous recursive process. Another aspect provides software or circuitry arranged to derive an output representing a pseudo division of a signal representing a numerator, by an input signal, by a continuous recursive process having the steps of:

multiplying the input by a previous output of the process, subtracting the result from a constant, and multiplying the result of the subtraction by the previous output. This enables the amount of processing to be reduced considerably. For 32-bit precision for example a division will require about 32“*” and 32“+” operations. In the case of the pseudo division, it can be reduced to: 2“*” and 2“+” operations, so it can be at least 16 times faster. It uses an approximation as explained below, which is sufficiently accurate provided the input is a series of values having only small changes between consecutive values.

Another aspect provides a detector arrangement for detecting multiple narrowband signals in an input signal, the arrangement having:

multiple adaptable filters coupled to the input signal and having frequency responses with an adaptable centre frequency, and an adaptable bandwidth; and

a controller for controlling the centre frequency and the bandwidth of respective ones of the filters, based on outputs of the filters, to track the narrowband signals,

the multiple filters being arranged in two or more rows of serially cascaded filters, the controller being arranged to control the filters such that in each row, individual filters track different ones of the narrowband signals, and in the different rows, the same narrowband signals are tracked, but in a different order, the controller further being arranged to use error gradients derived from the outputs of filters of one of the rows, and use residual power outputs from one of the filters in each of the rows.

Another aspect provides a detector arrangement for detecting multiple narrowband signals in an input signal, the detector arrangement having:

multiple adaptable filters coupled to the input signal and having frequency responses with an adaptable centre frequency, and an adaptable bandwidth;

a controller for controlling the centre frequency and the bandwidth of respective ones of the filters, based on outputs of the filters, to track the narrowband signals, and

an arrangement for removing duplicate detections of the same narrowband signal, based on frequencies and power levels of the detections.

Other aspects provide a method of using an output of the arrangement for monitoring or control purposes in voice or data processing equipment, a method of transmitting signalling information or user data using the arrangement to detect the signalling information or user data, or a method of offering a voice or data transmission service to subscribers using the above-referenced apparatus for the central office. These aspects recognise the value of the enhanced narrowband detector in improving various types of voice and data processing. Any of the preferred features above may be combined with any of the aspects of the invention, as would be apparent to those skilled in the art.

### BRIEF DESCRIPTION OF THE DRAWINGS

Embodiments of the invention will be described in more detail to show by way of example how the invention can be implemented, with reference to the drawings in which:

FIG. 1 shows a known telecommunications network including a narrowband detector,

FIG. 2 shows a known arrangement of an adaptive notch filter type narrowband detector,

FIG. 3 shows a narrowband detector according to a first embodiment of the invention,

FIG. 4 shows a narrowband detector, according to another embodiment of the invention,

FIG. 5 shows part of the controller of FIG. 4,

FIG. 6 shows a cascade of filters according to another embodiment of the invention,

FIG. 7 shows another cascade, according to another embodiment of the invention,

FIG. 8 shows a pseudo division method according to another embodiment of the invention, and

FIG. 9 shows a flag processing arrangement according to another embodiment of the invention,

### DETAILED DESCRIPTION

FIG. 3, Narrowband Detector

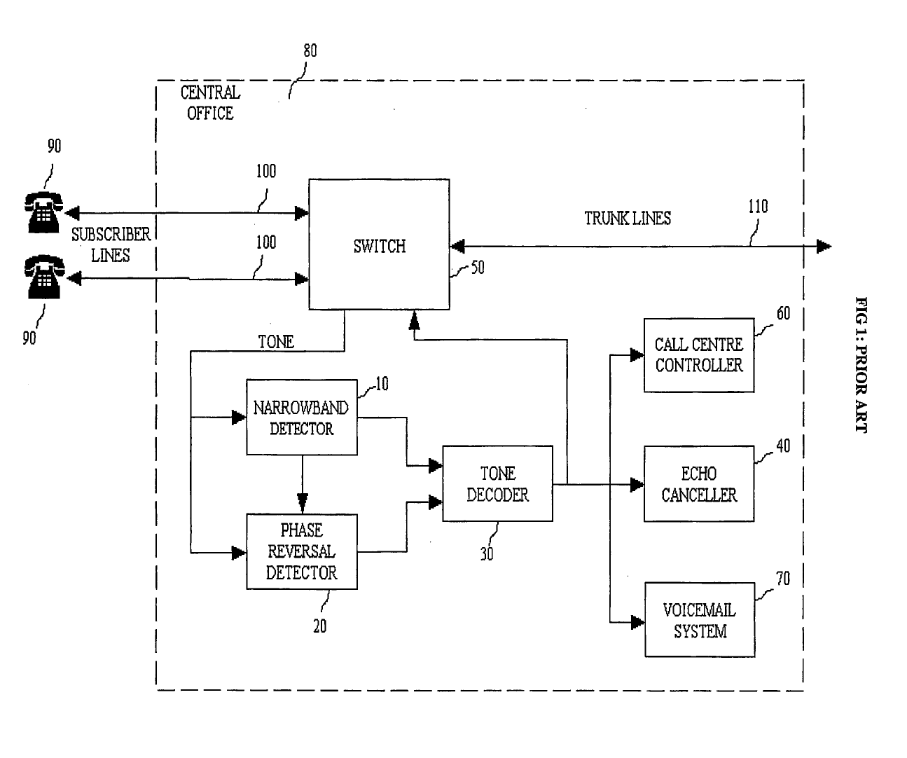

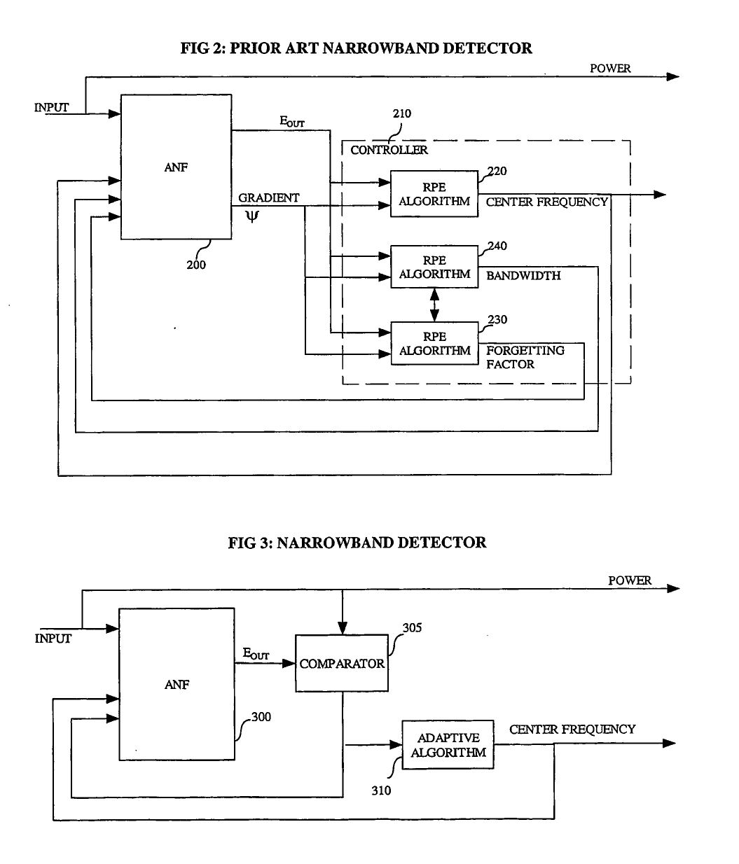

FIG. 3 shows a narrowband detector according to a first embodiment of the invention. It could be applied in the arrangement shown in FIG. 1 or in other applications. There is an ANF 300, which is fed by the input signal, and by one or more control signals from the controller which uses an adaptive algorithm 310. These control signals include the centre frequency. Other control signals may optionally be used, such as bandwidth. The ANF outputs a residual error power signal Eout which is compared to the input signal by a comparator 305. The relationship between these signals is used to control the ANF, either directly, or by influencing the controller. Other outputs of the ANF may also be used by the controller. As ANFs are well known and can be implemented without difficulty, there is no need to describe this function in more detail, and the reader is referred to appropriate text books or other publications, including those referenced above. In principle, the filter can be a bandpass filter, though overall the system is easier to implement if the filter is a notch filter.

Notably, the controller 310 also has the input signal as an input. This enables the advantages mentioned above in the summary of invention section, to be realised. Many variations or modifications can be envisaged while still obtaining the benefit of using the input signal in the adaptive algorithm for controlling the filter. In particular, many different types of filter and many different types of adaptive control algorithm can be used.

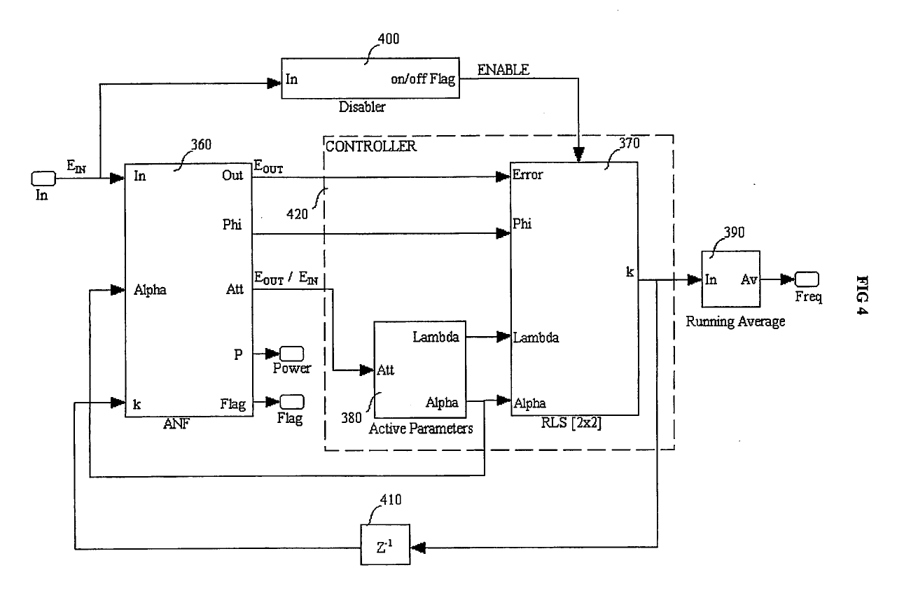

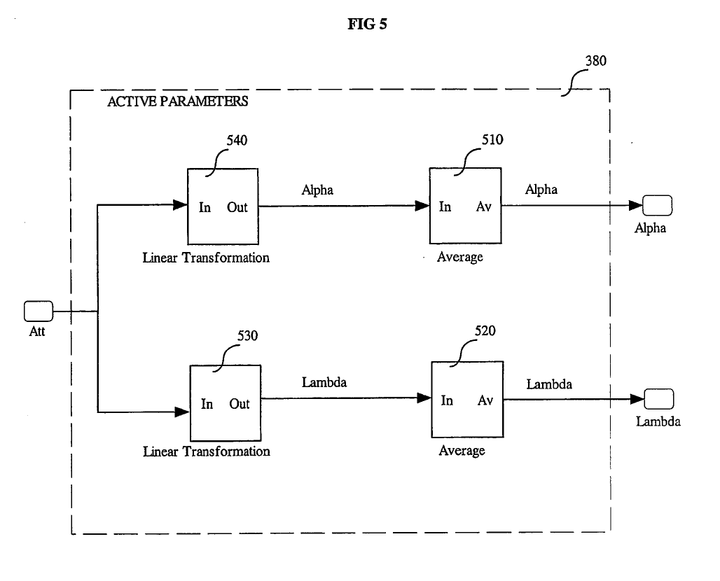

FIGS. 4, 5 Controller for Adaptive Filter

FIG. 4 shows another embodiment. The ANF 360 is aranged to output a residual power error signal (Eout or error), an error gradient, (Phi), a ratio (Att) of residual power to input power, (Eout/Ein), estimated power (P) of a detected narrowband signal, and a flag to indicate positive detection. The first three of these outputs are fed to the controller 420.

The controller 420 includes an RLS algorithm unit 370, for continuously updating a centre frequency value k for the ANF. This value is fed back to the ANF via a delay element 410. The delay element is an optional element provided to ensure that a new updated value of k is not used prematurely by the ANF. This is especially useful where the output is fed back to influence the next calculation. For example: at time n, the ANF's filter the input with their current center frequency (k), then feed the results to the RLS which work out a next value for k This will be used the next cycle (at time n+1) in the ANFs to filter the input and feed the result to the RLS. The delay effectively provides synchronisation which is usually preferred to asynchronous type operation.

The controller also includes an active parameters section 380. This section derives suitable values for the bandwidth (alpha) of the ANF, and the forgetting factor (lambda) for the RLS algorithm. More details of this section are described below with reference to FIG. 5. Notably the outputs of this active parameters section are dependent on the input signal (Ein), since the ratio of energies Eout/Ein is fed to the active parameters section. This enables the advantages set out above. The active parameters section may be incorporated with the controller or with the ANF as desired, without altering its function.

The RLS algorithm makes use of the error (Eout) and error gradient (Phi) output by the ANF. The frequency value k output by the RLS algorithm is smoothed by a time-averaging element 390 before being output to other parts of the system, e.g. a tone decoder. A disabler 400 is provided to disable the operation of the RLS algorithm depending on the input level (Ein). One reason for doing this is to prevent corruption of internal coefficients within the RLS algorithm when there is no input signal. This disabler is not essential, there are other ways of dealing with this problem. It is important at a system level.

FIG. 5 shows more details of one possible implementation of the active parameters section. Clearly other variations can be conceived. A linear transformation of the ratio Att (Eout/Ein) is carried out by element 530 to derive a value for the forgetting factor (lambda). Again the computation of the energies and the ratio can be implemented as part of the controller. A time averaging element 510 then smooths the output. Another linear transformation is carried out by element 540 to derive a value for the filter bandwidth (Alpha). Another time averaging element 520 is used to smooth this output

The forgetting factor is a value between 0 and 1 which influences how much the RLS algorithm to take into account past or historic values of its inputs. Hence a low value gives faster convergence but lower accuracy. A high value gives slow convergence but better accuracy. More accuracy is desired when the ANF has converged on the narrowband signal. This is indicated when the ratio Att is low, since in this case most of the narrowband signal is being removed by the ANF. Hence the linear transformation should have a negative slope. In principle it need not be linear, other more complex relationships could be used. It could even be a stepped or switched relationship.

A smooth relationship can help avoid an oscillatory response of the filter, which would otherwise increase convergence delay and reduce accuracy. Also, the relationship should be tailored to avoid extreme values, which could cause difficulties. For example a value of zero might cause divide by zero problems. A value of one might cause very slow convergence or no convergence at all. Hence the output can be constrained to be between 0.05 and 0.95 or similar values. The relationship can be implemented using conventional methods, for example using a multiplier for a linear relationship, and comparators for the limits. Alternatively, look-up tables could be used.

For the transformation to generate the bandwidth, similar considerations apply. A large bandwidth will give faster convergence, as there will be a steeper gradient in the frequency response away from the notch. Low values of bandwidth will give slower convergence but more accuracy. This follows because the frequency response of the ANF will have a sharper response at the peak. This in turn will lead to a greater error signal when the peak is not quite aligned with the corresponding peak in the frequency spectrum of the narrowband signal. Hence the transformation should be such that low values of Att lead to a low value for bandwidth. Again, a linear transformation is preferred, and extreme values should be limited. If the bandwidth is too wide, for example an extreme value of 1, this may cause numerical problems, such as overflow for fixed point calculations. An extreme value of zero may cause divide by zero problems. Also, If the bandwidth is made too narrow following convergence, then convergence may be lost.

The averaging of both outputs is useful to remove jitter. Jitter can be more of a problem largely because of the new dependence on the input signal. There is usually little jitter on the output of the notch filter. The severity of the problem depends on the characteristics of the input signal, and depending on the adaptive algorithm.

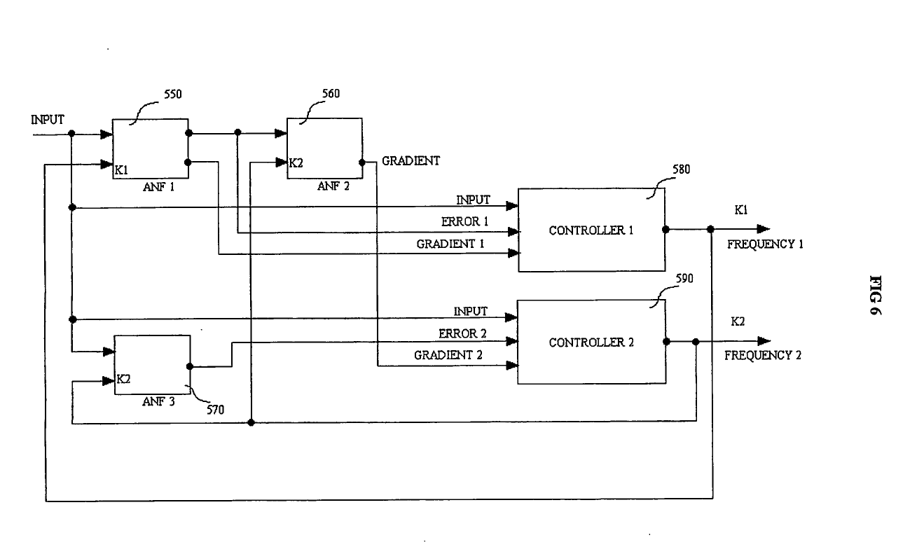

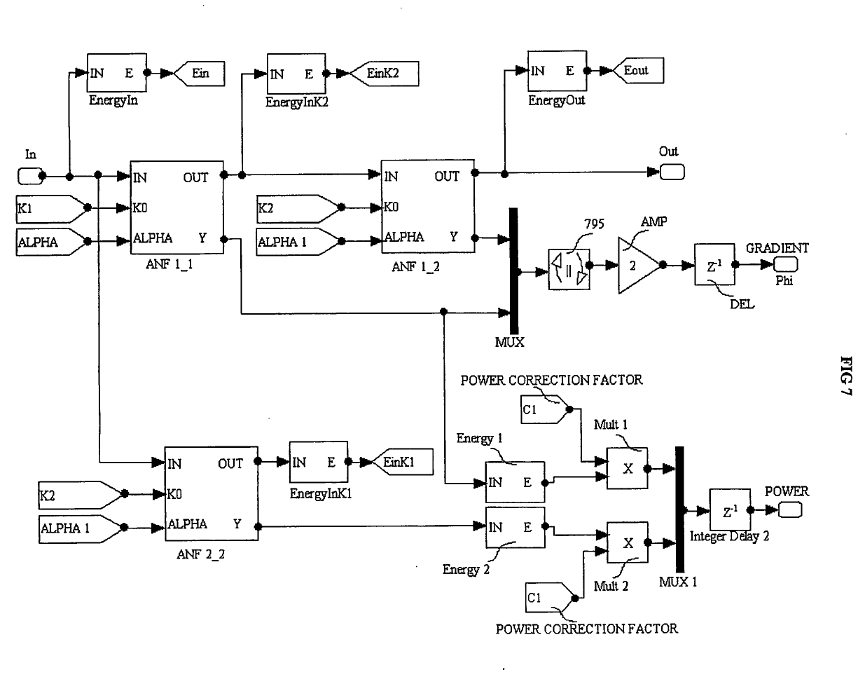

FIGS. 6, 7 Cascade of Filters

FIG. 6 shows a cascade of filters to enable multiple narrowband signals to be tracked simultaneously. It is known from the Cho article referenced above to have a serial cascade of filters. The same article also shows an alternative type of cascade known as a triangular cascade. This involves a parallel set of rows of serial cascades, each cascade ending with a filter controlled so as to track a different narrowband signal from those tracked by the end filter of others of the cascades. The triangular structure is an optimised form of a square structure. The controller may be implemented as separate controllers for each of the different narrowband signals, independently optimising the tracking of each of the signals. Alternatively it can be implemented as a single controller using an adaptive algorithm with several outputs. The single controller can adapt to optimise the overall tracking of all the narrowband signals.

A useful property of the serial cascade is that the filters cannot converge to the same narrowband signal, because the first filter in the cascade removes the narrowband signal it is tracking. Hence the second filter will track a different narrowband signal. A disadvantage of the serial cascade compared to the triangular cascade is that the convergence of the second filter is slower because it must wait until the first filter has converged. Also, the triangular scheme suffers from conflict when there are fewer narrowband signals than there are ANFs, as there is no inbuilt priority scheme to avoid multiple ANFs in the same cascade trying to track the same narrowband signal. This is the multiple detection problem.

In FIG. 6 a new arrangement is shown which uses features of both arrangements. There is both a serial cascade and a parallel arrangement. For the sake of clarity, a relatively simple arrangement having an order of 2 is shown, suitable for tracking two narrowband signals simultaneously. Of course, higher order arrangements with cascades of 3 or more ANFs are feasible, following the same principles. Two ANFs, ANF1 (550) and ANF2 (560) are coupled in series, the residual error from ANF1 being used as the input to ANF2. Controller 1, (580) is used to control the centre frequency of ANF1. Controller ANF2 (590) is used to control the centre frequency of ANF2. It is feasible to replace the two controllers with separate algorithms with a single controller having an algorithm having two or more separate outputs to track two or more narrowband signals. A third filter ANF3 (570) is shown coupled in parallel with ANF1. This filter is controlled by the same controller as is used for ANF2, and hence tracks the same narrowband signal as ANF2.

One key difference over the known arrangements is that the error gradients from the two or more filters in the serial cascade are used by the controllers, but the Eout/Ein ratios used by the controllers are not taken from the serial cascade. Instead these ratios are taken from the parallel coupled filters. Hence controller 1 uses the error gradient output and error output of ANF1. Controller 2 uses the error gradient output by ANF 2 and the error output by ANF 3. This enables the convergence speed of the parallel arrangement to be exploited, yet without losing the inherent prioritisation property of the serial cascade. This arrangement can be used with or without the above described feature of the controllers using the input signal, or ratio (Eout/Ein).

FIG. 7 shows another embodiment having a similar cascade arrangement and other features. In this figure, the controller or controllers are not shown, merely for the sake of clarity. 3 filters are shown, ANF 1-1, ANF 1-2 and ANF 2-2, corresponding to ANF1, ANF2 and ANF3 of FIG. 6. For each filter, there are 3 inputs, an input signal, a frequency k and a bandwidth (alpha), the latter two from the controller. Each filter is a conventional ANF having an error output (out) and another output (y) which is the bandpassed signal. The bandpassed signal is the output from a first stage of the ANF, the error output is output from a second stage. The first stage involves bandpassing the input signal to pass the band around the centre frequency. The second stage involves removing or “notching” the centre frequency from the bandpassed signal.

The ultimate outputs at the right hand side of the figure are two error gradients, one for each narrowband signal being tracked, for feeding to the controller and power levels for each of the narrowband signals. Other outputs include signal energy levels at the input, and at the output of each of the filters, for feeding back to the controller or for calculating the ratio Eout/Ein. In each case an energy level calculating element or circuit is shown for taking a continuous signal and determining an average energy level (illustrated as elements EnergyIn, EnergyInk1, EnergyInk2, and EnergyOut, respectively).

Outputs y from ANF1-1 and ANF 1-2 are fed via an optional multiplexer (“Mux”) to a series of elements for deriving an error gradient Phi. This is achieved in this implementation by a reordering operation to reorder for convenience the multiplexed vector output by the multiplexer in element 795 This is followed by stage labelled “AMP” to double the signal value, and a delay stage (labelled “DEL”) for synchronisation purposes as described above. The arrangement follows the same principle as described with reference to FIG. 6, in that the gradient is calculated from the outputs of the serially connected filters.

Outputs y from ANF1-2 and ANF2-2 are used to calculate the output power, again following the principle explained above with reference to FIG. 6. The outputs y are fed to energy calculation elements (Energy1, Energy2 respectively). The outputs of these elements are multiplied by power correction factors c1, c2, using multipliers Mult1 and Mult2 respectively. This is to take into account filter characteristics, which affect the levels output by the filters. These can be determined empirically, or calculated. They may depend on the frequency and bandwidth of the filters, in which case a range of correction factors can be calculated, from which a current factor can be selected using the current frequency and bandwidth values. The resulting power values are output for use by other parts of the system, optionally via a multiplexer (Mux1) and a delay element (Integer Delay 2). The delay is for synchronisation purposes as described above, so that the updated value is not used too soon by other parts of the system.

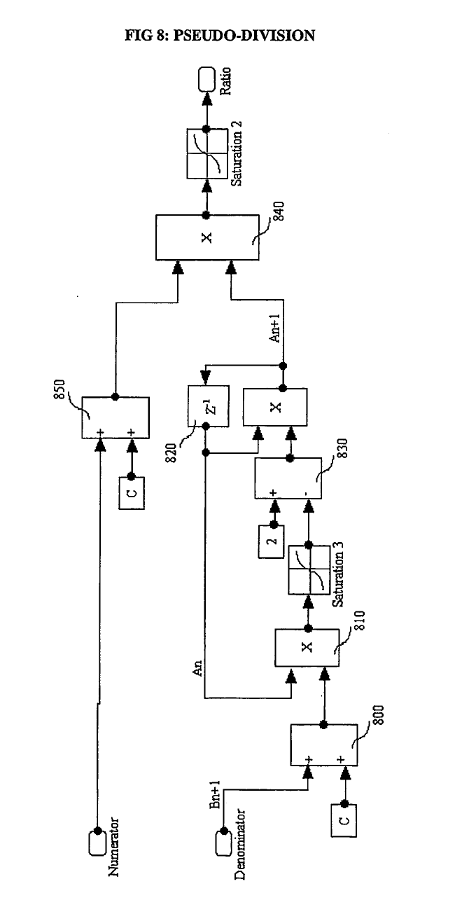

FIG. 8 Pseudo Division Method

FIG. 8 shows steps or elements for carrying out a pseudo division process, using multiply and add operations to carry out a division operation in a recursive manner. This can usefully be applied to calculating the ratio Eout/Ein, described above, or to many other applications. It uses an approximation which is sufficiently accurate provided the inputs are continuous signals, not random values, so the result of each successive calculation is not greatly different from the preceding calculation. This means where B is an input signal and A=1/B is the desired output, it can be seen that:

$$\begin{matrix}{A}_{n + 1} = 1 / {B}_{n + 1} & ( 1 ) \\ = 1 / [ {B}_{n} \cdot ( 1 + {e}_{n + 1} ) ] & ( 2 ) \\ = ( 1 - {e}_{n + 1 +} k {e}^{2} … ) / {B}_{n} & ( 3 )\end{matrix}$$

and where e is small, ke² . . . can be ignored, so

$$\begin{matrix}{A}_{n + 1} = 1 / [ {B}_{n} \cdot ( 1 + {e}_{n + 1} ) ] & ( 4 ) \\ = ( 1 - {e}_{n + 1} ) / {B}_{n} & ( 5 )\end{matrix}$$

in order to replace eₙ₊₁ in this equation, the following relation is used

$$\begin{matrix}{e}_{n + 1} = [ {B}_{n + 1} - {B}_{n} ] / {B}_{n} & ( 6 ) \\ = [ {A}_{n} \cdot {B}_{n + 1} ] - 1 & ( 7 )\end{matrix}$$

substituting this into equation (5) above gives:

$$\begin{matrix}{A}_{n + 1} = ( 1 - \{ [ {A}_{n} \cdot {B}_{n + 1} ] - 1 \} ) / {B}_{n} & ( 8 ) \\ = {A}_{n} ( 2 - [ {B}_{n + 1} \cdot {A}_{n} ] ) & ( 9 )\end{matrix}$$

This forms the basis of the arrangement shown in FIG. 8. Initially the denominator labelled Bₙ₊₁ is optionally added to a small constant c, using adder 800. This is simply to ensure the input is greater than zero, to prevent problems from a division by zero. Next, a multiplier 810 is used, to multiply the denominator Bₙ₊₁ by a previous output, Aₙ. This previous output is derived from the current output Aₙ₊₁ using a delay element 820. The output of the multiplier is fed to an adder 830, via a limiting element labelled “Saturation 3” which acts to limit the output of the multiplier, to limit the range, to ensure the approximation in the algorithm is not invalidated. Next the adder is used to subtract the output of the limiting element from the value 2. Finally, the output of the adder is multiplied by the previous result Aₙ, derived from the current output Aₙ₊₁ using the delay element.

This arrangement can result in significantly less processing than is used in a typical division operation of a microprocessor. Instead of the typical 32 or more processor clock cycles used for a division operation, this uses only 4, ( two adds and two multiplications). This can be reduced to two cycles for devices with a multiply-accumulate instruction. The saving is especially significant in applications such as the narrowband detector described above, using the ratio Eout/Ein, since this value must be continuously updated.

Once the divide operation has been carried out, the result is multiplied with the numerator, using multiplier 840. The numerator optionally has a small constant c added using adder 850 for use if a correction is desired. The output of this multiplier is passed through a limiter (labelled “Saturation2” in FIG. 8), to avoid extreme values.

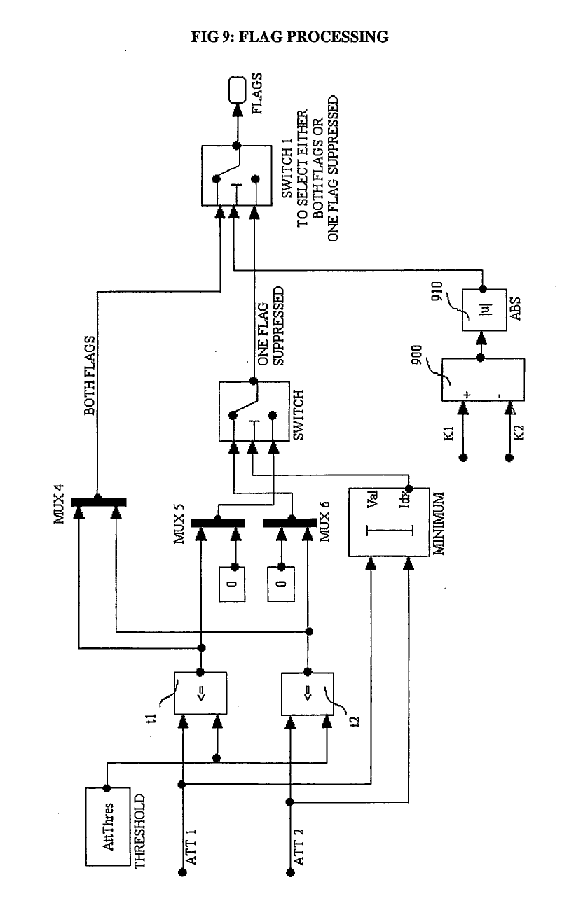

FIG. 9 Flag Processing Arrangement

The narrowband detector can optionally have flag outputs to indicate detection. They can be created by thresholding the ratio (Att) signal derived in the respective ANF or the controller. In any narrowband detector which is capable of tracking two or more narrowband signals, it is possible for the two or more filters to detect signals that are not intended to be separate narrowband signals. To be more certain of correct detection, particularly in applications where the number of concurrent narrowband signals is not predetermined, it is useful to be able to suppress detection of one narrowband signal if it is too close in frequency to, and of much lower power than another detected narrowband signal. FIG. 9 shows an arrangement to achieve this with a minimum of calculation overhead.

Two Att ratios, Att1 and Att2 are fed in from two ANFs. The respective centre frequencies k1 and k2 are fed in from the controllers. The difference in frequency values is determined by an adder 900, and the absolute difference is compared to a threshold at element 910. The output of this element is used to control switch1, which selects whether both flags are output, or whether one of the flags is suppressed. Which of the flags is suppressed is determined by the remainder of the arrangement, based on inputs Att1 and Att2. Both inputs are first compared to thresholds t1 and t2. Provided the inputs are above the respective thresholds, a positive flag is generated by these threshold elements. A comparator (labelled “minimum” determines which has the lower Att value, indicating a better convergence of the filter. The output of this is used to control a switch (switch 2) which determines which of the flags is suppressed. In the example shown, one flag is suppressed by using multiplexers mux5 and mux6 to feed the two inputs of switch 2. Mux5 passes one flag and sets one at zero. Mux6 passes the other flag, and sets the first at zero.

This arrangement can be used in conjunction with the cascade arrangements of FIGS. 6 or 7, or with other arrangements for detecting multiple narrowband signals.

Implementations for Telephone Call Processing

Any of the narrowband detector features described above can be implemented as part of a tone processor in a central office as shown in FIG. 1. In this case the requirements for accuracy and speed of detection are especially valuable. Signalling tones such as DTMF tones are widely used, and used for more different types of applications. Operators who offer telephone services to subscribers will often route calls over equipment in central offices belonging to other operators. Quality of calls and whether they meet the well established standards for handling signalling tones is a major problem. Because the installed base of central offices is so vast, the value in making improvements to existing central offices as well as in new installations, is huge. Typically the tone processing sections and other modules in the central office are implemented as software modules run on one or more DSPs (Digital Signal Processor). Accordingly, the narrowband detector features can be implemented in well known programming languages such as C or Ada, or others, as would be well known to those skilled in the art. The resulting code can be cross-compiled into a lower level language appropriate to run on a DSP, such as the fixed or floating point types made by TI or Motorola or others, or on a general purpose microprocessor, or any type of firmware, or programmable or fixed hardware, or any combination. The software can in principle be implemented as instructions or as combinations of data, instructions, rules, objects and so on. Some features can in principle be implemented in dedicated hardware for greater speed of operation.

Concluding Remarks and Other Variations

Other variations will be apparent to those skilled in the art, within the scope of the claims. Although described with reference to telecommunications applications, other applications are intended to be encompasses by the claims. Although described with reference to a notch filter, the aspects of the invention are clearly applicable to other types of filter. Although an RLS algorithm was used in the examples described, other types of algorithm can be used including other types of LMS (least mean squares) algorithm. Although described using bandwidth and forgetting factor as the signals for biassing the control, either of these can be used individually, or other factors can be used, within the scope of the claims. Other applications include test equipment, data transmission using modems, fax machines, monitoring, including mechanical vibration monitoring, and similar uses.

Above has been described a narrowband signal detector has an adaptable filter and a controller for controlling the centre frequency and the bandwidth of the filter, to track the narrowband signal. Better control of the filter can be achieved by basing the filter control on a comparison of output and input to the filter. The comparison gives a more direct measure of how well the filter is tracking the narrowband signal. In the case of a notch filter, if there is poor tracking. The control should be biased rapidly towards improved tracking speed. Otherwise, for good tracking, the control should be biased towards accuracy of tracking. This enables speed and accuracy of detection requirements to be met with less computational load. Applications include telecommunications signalling or data tone detection. Multiple narrowband signals can be detected by a cascade of filters.

1. A detector arrangement for detecting a narrowband signal in an input signal, the detector arrangement having: an adaptable filter coupled to the input signal and having a frequency response with an adaptable centre frequency, and a filter controller for controlling the filter, to track the narrowband signal, the controller being dependent on a relationship between the input signal and an output of the filter, the relationship indicating how closely the filter is tracking the narrowband signal.

2. The detector arrangement of claim 1, the comparison being a ratio of a characteristic of an output of the filter output as a proportion of a characteristic of the input signal.

3. The detector arrangement of claim 1, the filter having an adaptable bandwidth, the controller being arranged to control a bandwidth of the filter on the basis of the comparison.

4. The detector arrangement of claim 1 the controller having an adaptable forgetting factor, the forgetting factor being adaptable according to the comparison.

5. The detector arrangement of claim 1, the controller using an adaptive algorithm.

6. The detector arrangement of claim 5, the adaptive algorithm being a recursive least squares (RLS) algorithm.

7. The detector arrangement of claim 3, arranged to derive a bandwidth control signal from the input signal and the output of the filter, according to the comparison and to a mapping defining how the bandwidth control is derived.

8. The detector arrangement of claim 7, the mapping being a linear mapping with limiting of extreme values.

9. The detector arrangement of claim 7, arranged to smooth the bandwidth control signal to reduce jitter.

10. The detector arrangement of claim 2, arranged to derive the ratio using a recursive pseudo division process.

11. The detector arrangement of claim 1, additionally having multiple filters, and being arranged to track simultaneously multiple narrowband signals in the input signal.

12. The detector arrangement of claim 10, the multiple filters being arranged in two or more rows of serially cascaded filters, the controller being arranged to control the filters such that in each row, individual filters track different ones of the narrowband signals, and in the different rows, the same narrowband signals are tracked, but in a different order, the controller further being arranged to use error gradients derived from the outputs of filters of one of the rows, and use residual power outputs from one of the filters in each of the rows.

13. The detector arrangement of claim 11, arranged to remove duplicate detections of the same narrowband signal by different ones of the filters, based on frequencies and power levels of the detections.

14. The detector arrangement of claim 1 in the form of software.

15. The detector arrangement of claim 1 in the form of apparatus.

16. A tone processing arrangement having the narrowband detector arrangement of claim 1, and a tone decoder.

17. Apparatus for a central office, the apparatus having an arrangement for routing voice or data signals, and having the tone processing arrangement of claim 16, coupled to the routing arrangement.

18. Software or circuitry arranged to derive an output representing a pseudo division of a signal representing a numerator by an input signal, using a continuous recursive process.

19. Software or circuitry according to claim 18 wherein said continuous recursive process comprises the steps of: multiplying the input signal by a previous output of the process, subtracting the result from a constant, and multiplying the result of the subtraction by the previous output.

20. A detector arrangement for detecting multiple narrowband signals in an input signal, the arrangement having: multiple adaptable filters coupled to the input signal and having frequency responses with an adaptable centre frequency, and an adaptable bandwidth; and a controller for controlling the centre frequency and the bandwidth of respective ones of the filters, based on outputs of the filters, to track the narrowband signals, the multiple filters being arranged in two or more rows of serially cascaded filters, the controller being arranged to control the filters such that in each row, individual filters track different ones of the narrowband signals, and in the different rows, the same narrowband signals are tracked, but in a different order, the controller further being arranged to use error gradients derived from the outputs of filters of one of the rows, and use residual power outputs from one of the filters in each of the rows.

21. A detector arrangement for detecting multiple narrowband signals in an input signal, the detector arrangement having: multiple adaptable filters coupled to the input signal and having frequency responses with an adaptable centre frequency, and an adaptable bandwidth; a controller for controlling the centre frequency and the bandwidth of respective ones of the filters, based on outputs of the filters, to track the narrowband signals, and an arrangement for removing duplicate detections of the same narrowband signal, based on frequencies and power levels of the detections.

22. A method of using an output of the arrangement of claim 1 for monitoring or control purposes in voice or data processing equipment.

23. A method of transmitting signalling information or user data using the arrangement of claim 1 to detect the signalling information or user data.

24. A method of offering a voice or data transmission service to subscribers using the apparatus of claim 17.
